(19) United States
(12) Patent Application Publication
(10) Pub. No.: US 2026/0138391 A1
(43) Pub. Date: May 21, 2026

(54) METHOD AND APPARATUS FOR PRODUCING A CALIBRATED STAMPED PART

(71) Applicant: Thomas HRACH, Perchtoldsdorf (AT)

(72) Inventor: Thomas HRACH, Perchtoldsdorf (AT)

(21) Appl. No.: 18/705,872

(22) PCT Filed: Oct. 21, 2022
(86) PCT No.: PCT/EP2022/079415

§ 371 Date: Apr. 29, 2024

(30) Foreign Application Priority Data
Oct. 29, 2021 (AT) A 50859/2021

(51) Int. Cl. B44B 5/00; B21D 28/04; B21D 28/16; B21D 53/44; B21J 5/02; B44B 5/02

(52) U.S. Cl. CPC B44B 5/0052; B21D 28/04; B21D 28/16; B21D 53/44; B21J 5/027; B44B 5/022

(57) ABSTRACT

A method for producing a calibrated stamped part for use in the production of embossed products, in particular coins, from a flat, in particular rolled or drawn, stamped part (1), comprises the following steps:—a positioning step a), in which the flat stamped part (1) is positioned between an upper punch surface (4) and a lower punch surface (5), —a contact step b), after which the two punch surfaces (4, 5) are in contact with the flat stamped part (1), —a calibration step c), in which the flat stamped part (1) is plastically deformed until a predefined distance (A) is reached between the punch surfaces (4, 5), with material of the flat stamped part (1) being displaced laterally, and —at least one severing step d), in which the laterally protruding material (10) of the flat stamped part (1) is severed.

The invention relates to a method and an apparatus for producing a calibrated stamped part for use in the production of embossed products, in particular coins, from a flat, in particular rolled or drawn, stamped part.

For producing embossed products, such as coins, medals, small bars, etc., stamped parts are required, which parts correspond as precisely as possible to a predetermined shape or a predefined volume.

So that a finished embossed product is aesthetically especially pleasing, for example, the stamped part used for this purpose must have a precisely-defined thickness or size, a precisely-defined peripheral shape, and/or as smooth a surface as possible. If the stamped parts used for an embossing method have as identical a volume as possible before the embossing, the parameters of the embossing process can be optimized in order to obtain as high-grade, aesthetically pleasing and consistent a result as possible. In addition, this has the result that the service life of the embossing tools can be considerably extended.

Stamped parts used for the production of embossed products are usually stamped from a metal strip or a metal web that has been rolled to a desired thickness in the preliminary stage. Due to production requirements, however, the thickness of such a strip or such a web is not exactly constant over its width and length and can in positions or places be several tenths of a percent or even percents above or below the preset value.

The stamped parts for the production of embossed products can therefore undergo a calibration process before the embossing process, in which calibration process predefined values and shapes approximate as precisely as possible in particular the thickness and the outside periphery, i.e., the geometry, and thus the volume, of the stamped part.

Current processes often comprise multiple complicated process steps, so that they are configured not only in a time-consuming manner, but are also costly and technically complex. Stamped parts, which are, for example, too thin in places, must be discarded, while, by contrast, stamped parts, which are too thick or too large in places, must be classified according to excess and must undergo removal of material corresponding to the classification.

Regardless of the calibration to a predefined volume, it may be advantageous to compress the surfaces of the stamped parts to be embossed. If necessary, this is achieved, for example, by ball polishing of the stamped parts, which, however, is quite labor-intensive and costly.

The object of the invention is to make available a method and an apparatus for producing a calibrated stamped part for use in the production of embossed products of the above-mentioned type, which does not have the drawbacks of the state of the art. In particular, a method and an apparatus are to be provided with which a stamped part that is as exactly calibrated as possible, i.e., a stamped part with a predefined volume, can be produced quickly and effectively.

This object is achieved according to the invention with a method that has the features of Claim 1. In addition, this object is achieved with an apparatus that has the features of Claim 13.

Preferred and advantageous embodiments of the invention are the subject matter of the subclaims.

According to the invention, it is provided that the method comprises the following steps:
A positioning step, in which the flat stamped part is positioned between an upper punch surface of an upper punch and a lower punch surface of a lower punch oriented preferably essentially parallel thereto and central thereto, wherein the punch surfaces are preferably of the same size and are oriented centered relative to one another,
A contact step, in which one of the punches, preferably the upper punch, is moved along a common punch axis to the other punch or the two punches are to be moved relative to one another along the punch axis until the two punch surfaces are in contact with the flat stamped part,
A calibration step, in which the flat stamped part is deformed plastically by bringing the punches closer together, while the punch surfaces are in continuous contact with the flat stamped part, until a predefined gap is attained between the punch surfaces, wherein material of the flat stamped part is displaced laterally and protrudes over the punch surfaces, and
At least one severing step, in which material of the flat stamped part that protrudes laterally over the punch surfaces, transverse to the punch axis, is severed.

Within the framework of the invention, bringing one punch or one punch surface closer to the other punch or the other punch surface is understood as bringing the two punch surfaces closer together. This converging or moving of the two punch surfaces toward one another can be done by one of the punches remaining stationary and the other punch moving in the direction toward the stationary punch or by having the two punches be moved toward one another simultaneously or in succession.

Essentially a normal gap, i.e., a gap measured in the direction of the punch axis, between a position of the first punch surface and a corresponding, i.e., opposite, position of the other punch surface, is to be understood as a predefined gap between the punch surfaces.

Preferably, the flat stamped part is punched out from a material strip, a material web, or a plate. The flat stamped part can have, for example, the shape of a flat cylinder if a coin or medal is to be produced therefrom, or the shape of a flat rectangle, in particular with rounded corners, when a small bar is to be produced therefrom.

The flat stamped part has a top and a bottom, wherein one of the two sides or the two sides receives/receive embossing in a subsequent embossing method, i.e., in that the embossing punch(es) is/are applied and pressed thereinto. In the case of a stamped part for producing a coin or medal, the top and the bottom are, for example, circular surfaces. Due to production requirements, in general, there is no exact planar parallelism between the top and the bottom of the stamped part.

Before the calibration step, the flat stamped part is positioned in a positioning step central to the lower punch surface. The central positioning of the stamped part (which can also be carried out central to the upper punch surface or as a rule is carried out central to the two punch surfaces) is preferably implemented using a robot or another suitable centering system, for example a purely mechanical system.

It is ensured by the positioning step that the stamped part is oriented as centered as possible relative to the punch surfaces, so that it does not protrude disproportionately far over the punch surfaces on one side. In the case of a non-centered stamped part, it may occur that the stamped part does not protrude over the punch surfaces at many positions after the calibration step, so that the stamped part does not have the predefined volume after the severing step.

The predefined gap that the punch surfaces have relative to one another at the end of the calibration step is for logical reasons of the same size or smaller than the smallest gap between the top and the bottom of the stamped part that is still not calibrated. Therefore, from all areas in which the gap between the top and the bottom is greater than the predefined gap, material of the stamped part is displaced relative to the edge of the punch surfaces, while the stamped part is deformed plastically.

Because of the preferably essentially parallel orientation of the punch surfaces in the method according to the invention, the top and the bottom of the stamped part after the calibration step are also oriented exactly parallel relative to one another. In a later embossing method, this makes possible an extremely precise and uniform embossing.

It is also conceivable, however, that at least one of the punch surfaces does not run parallel to the other punch surface at least in places. For example, one of the punch surfaces can be configured slightly concave or inversely pyramidal, so that the thus calibrated stamped part has a greater thickness in the center than on the edge.

With the method according to the invention, it is especially preferred when the flat stamped part overall has the same predefined thickness after the calibration step, i.e., when both the upper and lower punch surfaces in each area that applies to the top or bottom of the stamped part are flat and do not have any projections or steps. In this case, after the calibration step, the punch surfaces have the predefined gap relative to one another over their entire surface, and the calibrated stamped part has a uniform thickness or material strength.

It is also conceivable, however, that the upper punch surface and/or the lower punch surface has/have projections or stages in each area that applies to the top or bottom of the stamped part in order to produce, for example, a calibrated stamped part with a thickened edge area. Within the framework of the invention, the punch surfaces are brought closer together in the calibration step until a predefined gap is attained between the punch surfaces; therefore, it is to be understood that after the converging or calibration, the punch surfaces have the predefined gap relative to one another at least in a certain place or at a certain position. This also means, however, that the gap between the punch surfaces at the end of the calibration step does not have to be uniformly large over their entire surface. For example, in the places of the top or bottom of the stamped part, in which because of the subsequent embossing method, it is advantageous to have more material available at the end of the calibration step, there can be a greater gap between the punch surfaces than in places in which little material is required.

Another advantage of the method according to the invention lies in the fact that the uppermost layers of the material on the top and the bottom of the flat stamped part are compressed during the calibration step. The top and the bottom of such a calibrated stamped part have a smoothed and homogeneous (evenly-compressed) surface, by which the embossing image produced in a subsequent embossing method on the stamped part is especially fine and precise.

In the at least one severing step following (in particular directly thereafter) after the calibration step, material of the stamped part that protrudes over the punch surfaces that are preferably of the same size and are centered relative to one another, transverse to the punch axis, is severed. The outside periphery of the stamped part therefore corresponds, after the severing step, to the outside edges of the stamped surfaces. In addition, the stamped part, after the calibration step, has a predefined thickness, since the thickness of the stamped part is directly connected to the gap between the punch surfaces after the calibration step because of the plastic deformation of the stamped part during the calibration step. At the end of the method according to the invention, the stamped part therefore has an exactly predefined volume and an exactly predefined shape.

Implementations of the method according to the invention in which a flat stamped part made of metal or a metal alloy is used are preferred. The metal or at least one metal of the alloy can be selected from the group of the following metals: copper, silver, gold, platinum, nickel, brass, aluminum, zinc, tin, or iron. The stamped part can also consist of several metal or metal alloy layers, for example a nickel layer between two copper-nickel layers or a nickel layer between two nickel-brass layers. Metals can be put especially precisely into a desired shape by plastic deformation. In addition, in the case of metals, material layers can be compressed with sufficient pressure in the area of those contact surfaces to which pressure is applied.

Within the framework of the invention, the punches can be brought closer together in the calibration step in a single working stroke or in multiple working strokes. For example, the converging can be carried out by a number of closely-spaced working strokes, which gradually always turn out to be wider or deeper, so that the gap between the punch surfaces relative to one another decreases (continuously or abruptly) over the number of working strokes. Such a sequence of working strokes can also be referred to as shaking, optionally high-frequency shaking. Also, in the case of multiple working strokes or during shaking, the punch surfaces, however, remain in permanent contact with the flat stamped part during the calibration step.

With the working stroke or in the case of working strokes, approximately as much force or pressure is exerted by the punch on the flat stamped part as is necessary in the case of a subsequent embossing method for impressing a distinct embossing in the stamped part. The force required during the working stroke or the pressure to be applied therefore depends on the material or the material composition of the stamped part.

With the method according to the invention, the moving of the punch or the punches and therefore also bringing it or them into contact in a feed stroke is carried out. The feed stroke is carried out preferably with lower force or lower pressure and/or preferably higher speed than the at least one working stroke. This allows the punch surfaces to be brought into contact as fast as possible with the flat stamped part, since for this purpose, a drive mode or drive unit other than that with which the punches are brought closer together relative to one another in the calibration step can be used. The drive mode or the drive unit for the working stroke can produce a high force or a high pressure, but the punches tend to approach one another fairly slowly.

The flat stamped part is held in position by the feed stroke or by bringing the punch surfaces into contact with the flat stamped part in the contact step. Thus, in the subsequent calibration step, great force or great pressure can be exerted on the stamped part, without the stamped part spreading out laterally under the pressure exerted by the punch surfaces during the working stroke, i.e., sliding in relation to the punch axis. Such a spreading-out or sliding would lead to a false or uncontrolled or undesirable deformation of the stamped part.

It is preferred when a placing step, in which the flat stamped part is placed on the lower punch surface, is carried out directly before or after the positioning step, or during it. Within the framework of the invention, however, it is also conceivable that during the contact step, the stamped part is held between the punch surfaces by a system, in particular the positioning system.

It is especially preferred when an upper punch surface and a lower punch surface with a smooth surface are used in the method. This makes it possible to produce calibrated stamped parts with tops and bottoms that are extremely smooth and especially easily embossed in a subsequent embossing method.

When the calibration step replaces the embossing method or serves as a pre-embossing method, the upper punch surface and/or the lower punch surface can, however, also have a corresponding embossing image that consists of ridges and recesses. For example, one of the sides of the stamped part (the top or the bottom) that is not embossed in a subsequent embossing method can become pressed into a pattern during the calibration step.

It is also preferred when with the method according to the invention, an upper punch surface and a lower punch surface with a shape similar to the shape of a top and a bottom of the flat stamped part that is essentially the same size are used. Within the framework of the invention, this means that the punch surfaces can be made larger or smaller than the top and the bottom of the stamped part, but have the same edge. When the stamped part is provided, for example, for the production of a coin and therefore has a circular top and bottom, the punch surfaces are preferably also circular.

Within the framework of the invention, implementations of the method according to the invention are preferred, in which before the positioning step, a classifying step is carried out, in which classifying step flat stamped parts are divided into at least two groups. A first group contains any flat stamped parts whose minimum size or thickness is at least as large as a predefined size or thickness, and another group contains any flat stamped parts whose minimum size or thickness is smaller than a predefined size or thickness. The flat stamped part for the other method steps, i.e., the positioning step, the contact step, the calibration step, the severing step and other steps, is removed from the first group. Thus, it is ensured that the size or thickness of the calibrated stamped part corresponds in any case to at least one predefined size or thickness, since with the method according to the invention, an excessively thick area of the flat stamped part can be simply reduced, while an area of the stamped part that is too thin can be built up, but it is difficult to do so. Then, it is ensured by the method according to the invention that the predefined volume is not exceeded, and the stamped part or its volume is brought into an exactly predefined shape for a subsequent embossing method.

It is preferred when a flat stamped part with a top and a bottom that are essentially of the same size, which top and bottom are larger than the punch surfaces, is used, so that after the contact step, the stamped part protrudes over the punch surfaces at least in places. This ensures that the stamped part has at least the desired volume for producing the embossed product, wherein projecting material is severed in the severing step, but it is difficult or impossible to add new material at a later time.

Within the framework of the method according to the invention, punch surfaces with an outside edge can be used, wherein in the severing step or optionally in one of the severing steps, the material that protrudes outwardly over the outside edge and transverse to the punch surface is severed. Thus, the outside periphery of the stamped part can be matched exactly.

Instead, or in addition, however, punch surfaces with a recess that in each case are of the same size and are centered relative to one another, which recess is bounded by an inside edge of the punch surface, can be used. In the severing step or optionally in one of the severing steps, in the case of such punch surfaces, the material that protrudes inwardly over the inside edge, transverse to the punch axis, is severed. Thus, the shape of a recess of the stamped part can be matched exactly.

Within the framework of the method according to the invention, a closed-surface flat stamped part can thus be used, i.e., a stamped part without through openings connecting the top and the bottom, wherein in this case, punches with closed-surface punch surfaces are also used. In the calibration step, in the case of such a stamped part, material is displaced only outwardly. It is also possible, however, that a circular, flat stamped part is used, as required, for example, for producing bimetallic coins, such as euro coins. As the punch surfaces that are also circular and are provided for this purpose are brought closer together, material is also (or only) displaced inwardly in the calibration step.

For severing the material that protrudes outwardly over the outside edge and transverse to the punch axis, a cutting-edge geometry that runs with a cutting edge around the upper punch or around the lower punch can be provided. The cutting-edge geometry is arranged at some distance from the stamped part before the severing step e) or optionally in one of the severing steps e) and is moved in the severing step in the direction of the punch axis to the other punch at least to the extent that the material that protrudes outwardly is severed or sheared off by the cutting edge. The cut or severed material remnants thus produced can be especially easily collected, e.g., absorbed.

It is possible-although not preferred-when the material that protrudes outwardly over the outside edge and transverse to the punch axis is severed in a different way. For example, this material can also be turned or milled.

For severing the material that protrudes inwardly over the inside edge and transverse to the punch axis in the severing step or optionally in one of the severing steps, an inside punch guided in the upper punch or in the lower punch, which inside punch has a cutting edge running inside the recess, can be provided. The inside punch is arranged at some distance from the stamped part before the severing step and is moved in the severing step along the punch axis to the other punch at least to the extent that the material that protrudes inwardly is severed or sheared off by the cutting edge. Also, material remnants that are especially easily collected, for example, absorbed, can be produced in this connection.

Also, in this case, it is possible—although not preferred—when the material that protrudes over the inside edge is severed in a different way, e.g., by inward-turning or milling.

In the case of circular stamped parts, the material that protrudes over the outside edge of the punch surfaces can simultaneously be severed with the material that protrudes over the inside edge. First, however, the material that protrudes over the outside edge and then, in another severing step, the material that protrudes over the inside edge can also be severed, or vice versa.

It is conceivable—although not preferred—when a lower (or upper) punch is used for the method according to the invention, in which punch the punch surface is arranged in a trough, so that outwardly, a circumferential base is formed around the punch surface. In the case of a flat stamped part inserted into the trough, material is displaced outwardly during the calibration step until it accumulates at the base and at the same time is displaced inwardly until it protrudes inwardly over the inside edge. Then, in the severing step, only the material that protrudes over the inside edge has to be severed or cut.

The invention also relates to an apparatus for producing a calibrated stamped part for use in the production of embossed products, in particular coins, from a flat stamped part.

The apparatus according to the invention has an upper punch and a lower punch with a common punch axis, and an upper punch surface of the upper punch is oriented parallel to a lower punch surface of the lower punch that is centered thereto and to the punch axis. Preferably, the punch surfaces are of the same size.

The apparatus according to the invention has at least one drive unit, with which one of the punches can move toward the other punch or the two punches can move toward one another along the punch axis, or the punches can be brought closer to one another along the punch axis.

In the case of the apparatus according to the invention, material that protrudes laterally over the punch surfaces and transverse to the punch axis can be severed using at least one severing means.

The apparatus according to the invention is suitable for implementing the method according to the invention, so that preferred feature combinations, which relate to the method according to the invention, can also be installed in an appropriate manner on the apparatus according to the invention and vice versa.

Preferably, the apparatus has a positioning unit, with which the flat stamped part can be positioned centered between the punch surfaces and preferably placed on one of the punch surfaces. Within the framework of the invention, it is also conceivable that the stamped part is held using the positioning unit between the punch surfaces until the latter are in contact with the stamped part. In this case, the stamped part can be placed either on one of the punch surfaces or held “free” between the punch surfaces. It is ensured by the positioning unit that the stamped part is oriented as centered as possible to the punch surfaces.

Within the framework of the invention, embodiments are conceivable in which the drive unit, or with the presence of multiple drive units, at least one of the drive units, can be operated in at least two drive modes. In a feed mode, the punch or the punches can be moved in the contact step with a feed stroke. In an operating mode, the punches can be brought closer to one another with a working stroke, wherein the working stroke is embodied in the calibration step of the method according to the invention. With the drive unit, in the working mode, greater force can be exerted on the punch(es) than in the feed mode. Preferably, however, the speed at which the drive unit moves the punch(es) is higher in the feed mode than in the working mode.

Also, within the framework of the invention, embodiments are conceivable in which the apparatus has at least two drive units. With a feeding drive unit, the punch(es) can be moved with a feed stroke, and with a working drive unit, the punches can be brought closer to one another with a working stroke. With the working drive unit, in this case, greater force can be exerted on the punch(es) than with the feeding drive unit, wherein, however, the punches with the feeding drive unit can preferably run faster than with the working drive unit.

Preferably, the severing means is a cutting-edge geometry running with a cutting edge around the upper punch or around the lower punch, which cutting-edge geometry can move along the punch axis to the other punch.

When the apparatus according to the invention for producing stamped parts with a recess, such as, for example, circular stamped parts, is provided, the severing means is preferably an inside punch that is guided in a central recess of the upper or lower punch, which recess runs in the direction of the punch axis, central to the punch surfaces. The inside punch has a cutting edge running inside the recess and can move along the punch axis to the other punch.

Also possible within the framework of the invention are embodiments in which a punch has both the severing means with the cutting-edge geometry and the severing means with the inside punch or in which one of the punches has one severing means and the other punch has the other severing means.

The apparatus or its drive(s) can be set up in such a way that one or optionally more of the severing means or any of the severing means can move with the drive unit or optionally one of the drive units to move the punches and bring them closer together. It is also conceivable, however, that one or optionally more of the severing means or any of the severing means has a separate cutting drive unit.

Within the framework of the invention, it can be provided that the drive unit has a pneumatic drive or a hydraulic drive or optionally that at least one of the drive units has a pneumatic drive and/or at least one of the drive units has a hydraulic drive. Preferably, the drive unit with which the working stroke is carried out has a hydraulic drive, since greater forces can thus be produced. If the feed stroke and the working stroke take place with different drive units, the drive unit with which the feed stroke is carried out preferably has a hydraulic drive, since the punch can thus move faster.

It is also possible within the framework of the invention that the drive unit or optionally that at least one of the drive units has an electric, magnetic, or mechanical drive. For example, an individual drive unit used for feed stroke and working stroke can have such a drive with at least two gearing stages (a gearing stage for the feed stroke and a gearing stage for the working stroke).

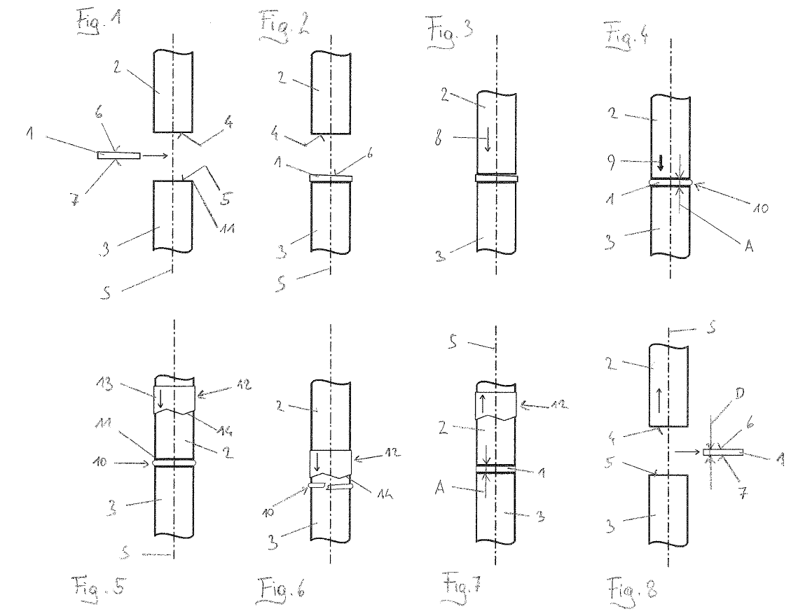

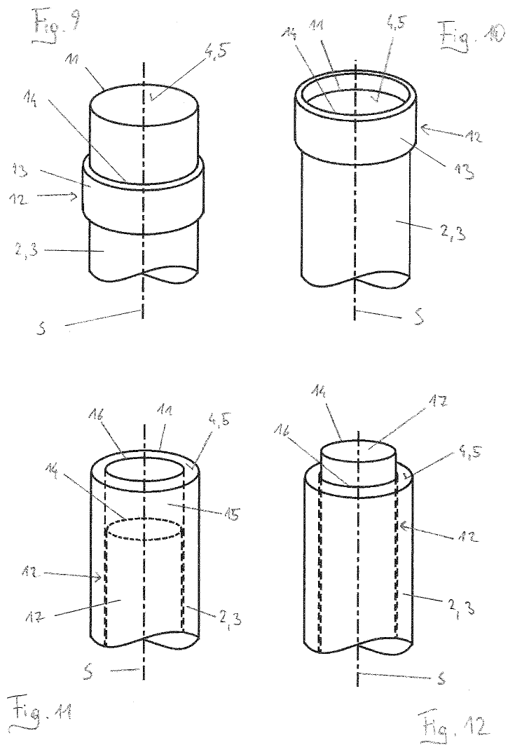

Additional details, features, and advantages of the invention are given in the description below, which refers to the accompanying drawings, in which preferred embodiments are depicted. Here:
FIGS. 1 to 8 show the sequence or process steps of a method according to the invention in accordance with a preferred implementation,

FIGS. 9 and 10 show a first embodiment of a punch used for the preferred implementation, and

FIGS. 11 and 12 show another embodiment of the punch used for the preferred implementation.

FIGS. 1 to 8 show the sequence of an especially preferred implementation of a method according to the invention in simplified form.

In a positioning step that is depicted in FIGS. 1 and 2, a flat stamped part 1 is positioned between an upper punch 2 and a lower punch 3.

The upper punch 2 has an upper punch surface 4 directed in the direction of the lower punch 3, which upper punch surface 4 is oriented parallel to a lower punch surface 5 of the lower punch 3. The punches 2, 3 and the punch surfaces 4, 5 are centered relative to one another and around a punch axis S.

The flat punch part 1 is punched out, for example, from a drawn or rolled material strip, in particular a metal strip. It has a flat top 6 and a flat bottom 7, which are essentially of the same size. The top 6 and/or the bottom 7 are the surface(s) to be embossed of the flat stamped part 1 in a subsequent embossing method in accordance with the method according to the invention. Due to production requirements, the top 6 and the bottom 7 of the stamped part 1—as is depicted in enlarged form in FIGS. 1 and 2—a re not oriented exactly parallel to one another before the calibration step c) of the method according to the invention.

In the positioning step a), the flat stamped part 1 is oriented central to the punch surfaces 4, 5 and therefore also to the punch axis S and placed on the lower punch surface 4 in a subsequent placing step a1). For the positioning and optionally placing of the rolled stamped part 6, a robot, not shown, or a mechanical positioning system can be used.

In a contact step b) depicted in FIG. 3, the upper punch 2 is moved in the direction of the lower punch 3 until the upper punch surface 4 comes into contact with the flat stamped part 1. Moving the punches 2, 3 onto one another in the contact step b) is done by a feed stroke 8 of the upper punch 2.

At the end of the contact step b), both the upper punch surface 4 and the lower punch surface 5 are in contact with the flat stamped part 1—or more precisely with the top 6 and the bottom 7 of the flat stamped part 1, so that the stamped part 1 is clamped in position by the punches 2, 3.

Depicted in FIG. 4 is a calibration step c), in which the upper punch 4 is brought closer together with the lower punch 3 using a working stroke 9 until a predefined gap A between the upper punch surface 4 and the lower punch surface 5 is attained. The predefined gap A exists at least between a position of the upper punch surface 4 and the corresponding, i.e., opposite, position of the lower punch surface 5.

Since the flat stamped part 1 is deformed plastically during the calibration step c), it has essentially a predefined thickness D after the calibration. In this case, the stamped part 1 is deformed plastically, so that its top 6 and its bottom 7 are oriented exactly parallel to one another. Excess material 10 of the flat stamped part 1 protrudes laterally and transverse to the punch axis S over the punch surfaces 4, 5.

It can be seen in FIG. 4 that excess material 10 of the stamped part 1 extends outwardly over outside edges 11 of the punch surfaces 4, 5.

After the calibration step c), this excess material 10 that protrudes laterally outwardly and transverse to the punch axis S over the punch surfaces 4, 5 or their outside edges 11 is severed using a severing means 12 in a severing step d) depicted in FIGS. 5 and 6.

The severing means 12 can move along the upper punch 2 in the direction of the punch axis S and has a cutting-edge geometry 13 with a cutting edge 14 that runs around the upper punch 2.

In the severing step d), the severing means 12 is moved in the direction of the lower punch 3 until the cutting edge 13 has been run past to the outside edges 11 of the punch surfaces 4, 5 and the excess material 10 that protrudes from above has been severed, or more precisely sheared off.

The excess material 10, which can shatter into multiple parts, can be collected in an area, not shown, or can be removed by a removing means, not shown, for example a suction apparatus.

In FIGS. 5 to 7, the severing means 12 is depicted with a serrated cutting edge 14, but within the framework of the invention, the cutting edge 14 can also have an essentially straight (as well as horizontal or oblique) path.

After the shearing-off or cutting or severing of the excess material 10, the severing means 12 is moved away again from the lower punch 3 at the upper punch 2 and in the direction of the punch axis S.

After the severing step d), the calibrated flat stamped part 1, i.e., pressed and cut to a predefined volume, is removed or forwarded for additional processing, such as surface preparation, edge extension, embossing, etc., for example using a robot, not shown, or a mechanical removal apparatus. In order to release the stamped part 1, the punches 2, 3 are moved away from one another or at least one of the punches 2, 3 is moved away from the other punch 3, 2.

FIGS. 1 to 8 show the method according to the invention in greatly simplified form. Even implementations of the process according to the invention deviating therefrom, in which, for example, the severing means 12 is guided along the lower punch 3 and is moved, or in which another type of severing means 12 is used, fall under the scope of the invention. In particular, it is possible that one of the punches 2, 3 is moved toward the other punch 3, 2 or that one of the punches 2, 3 is brought closer to the other punch 3, 2; the cutting tool 12 is guided, however, on the other punch 3, 2.

FIGS. 9 and 10 show a first embodiment, and FIGS. 11 and 12 show a second embodiment of the upper punch 2 or lower punch 3 for implementing the method according to the invention. In the depicted embodiments, the punches 2, 3 and their punch surfaces 4, 5 are made essentially circular, so that these punches 2, 3 are used in particular for the calibration of flat stamped parts 1, which are embossed in a subsequent embossing method to form coins or medals.

In FIGS. 9 and 10, a punch 2, 3 is depicted with a severing means 12, which is provided for severing excess material 10, which, after the calibration step, protrudes laterally outward and transverse to the punch axis S over the punch surfaces 4, 5 or their outside edges 11.

For this purpose, the severing means 12 has the cutting-edge geometry 13 with the cutting edge 14 running around the punches 2, 3. During movement of the severing means 12 in the direction of the punch axis S, the cutting edge 14 moves directly past the outside edge 11 of the punch surface 4, 5 of the punch 2, 3. As in the case of shears, the excess material 10 that protrudes over the punch surfaces 4, 5 is sheared off between the outside edge 11 and the cutting edge 14.

In FIG. 9, the severing means 12 is depicted at some distance from the punch surface 4, 5 of the punch 2, 3, and in FIG. 10, the severing means 12 is depicted moved along the punch axis S, to the extent that the cutting edge 14 is completely moved past on the outside edge 11 of the punch surface 4, 5.

The punch 2, 3 depicted in FIGS. 11 and 12 has a recess 15, which also finds a counterpart in the punch 3, 2 arranged opposite it. The punch surface 4, 5, as well as the counterpart punch surface 5, 4, has a circular shape with an inside edge 16 bounding the recess 15.

A severing means 12 is guided in the recess 15, which severing means is provided for severing excess material 10, which after the calibration step laterally protrudes inwardly and transverse to the punch axis S over the punch surfaces 4, 5 or their inside edges 16.

In the depicted embodiment, the severing means 12 has an inside punch 17 with a cutting edge 14 running inside the recess 15. When the severing means 12 moves in the recess 15 of the punch 2, 3 in the direction of the punch axis S directly past the inside edge 11 of the punch surface 4, 5 of the punch 2, 3, the cutting edge 14 of the inside punch 17 moves and shears off excess material 10 that protrudes from above.

Also conceivable within the framework of the invention are embodiments in which the punch 2, 3 has a circular punch surface 4, 5 and has both a severing means 12, as depicted in FIGS. 9 and 10, which is used to sever excess material 10 that protrudes outwardly, and a severing means 12, as depicted in FIGS. 11 and 12, which is used to sever excess material 10 that protrudes inwardly.

It is also conceivable within the framework of the invention that in the case of two opposite punches 2, 3 with circular punch surfaces 4, 5, one of the punches 2, 3 has a severing means 12, as depicted in FIGS. 9 and 10, which is used to sever excess material 10 that protrudes outwardly, and the other punch 3, 2 has a severing means 12, as depicted in FIGS. 11 and 12, which is used to sever excess material 10 that protrudes inwardly.

The above-described embodiments of the punches 2, 3 or the severing means 12 are conceivable within the framework of the invention just like punches 2, 3 for implementing the method according to the invention, which punches are not circular in cross-section, i.e., for example even in the case of punches 2, 3 that in cross-section have the shape of a rectangle, in particular with rounded corners, or an oval, or a different geometric shape.

In FIGS. 5 to 7, the severing means 12 is depicted with a serrated cutting edge 14 and in FIGS. 9 to 12 with a straight cutting edge 14. The cutting edge 14 can, however, be serrated or straight in all depicted variants, but also can be made fluted, toothed or oblique.

### REFERENCE SYMBOL LIST

1 Flat stamped part
2 Upper punch
3 Lower punch
4 Upper punch surface
5 Lower punch surface
6 Top (stamped part)
7 Bottom (stamped part)
8 Feed stroke
9 Working stroke
10 Excess material
11 Outside edge
12 Severing means
13 Cutting-edge geometry
14 Cutting edge
15 Recess
16 Inside edge
17 Inside punch
S Punch axis
A Predefined gap
D Predefined thickness

1. Method for producing a calibrated stamped part for use in the production of embossed products, in particular coins, from a flat, in particular rolled or drawn, stamped part (1), comprising the following steps:
A positioning step a), in which the flat stamped part (1) is positioned between an upper punch surface (4) of an upper punch (2) and a lower punch surface (5) of a lower punch (3) oriented preferably essentially parallel thereto and central thereto, wherein the punch surfaces (4, 5) are preferably of the same size and are oriented centered relative to one another,
A contact step b), in which one of the punches (2, 3), preferably the upper punch (2), is moved along a common punch axis (S) to the other punch (3, 2) or the two punches (2, 3) are to be moved relative to one another along the punch axis (S) until the two punch surfaces (4, 5) are in contact with the flat stamped part (1),
A calibration step c), in which the flat stamped part (1) is deformed plastically by bringing the punches (2, 3) closer together, while the punch surfaces (4, 5) are in continuous contact with the flat stamped part (1), until a predefined gap (A) is attained between the punch surfaces (4, 5), wherein material of the flat stamped part (1) is displaced laterally and protrudes over the punch surfaces (4, 5), and
At least one severing step d), in which material (10) of the flat stamped part (10) that protrudes laterally over the punch surfaces (4, 5), transverse to the punch axis (S), is severed.

2. Method according to claim 1, characterized in that for the method, a flat stamped part (1) made of metal or a metal alloy, in particular copper, silver, gold, platinum, nickel, brass, aluminum, zinc, tin, iron, or an alloy that contains one or more of these metals, is used.

3. Method according to claim 1, characterized in that the punches (2, 3) are brought closer together in the calibration step c) in a single working stroke (9) or in multiple working strokes (9), in particular a number of closely-spaced working strokes (9).

4. Method according to claim 3, characterized in that in the contact step b), the moving of the punch (2, 3) or the punches (2, 3) in a feed stroke (8) is carried out, and in that the feed stroke (8) is carried out with lower force and/or preferably higher speed than the at least one working stroke (9).

5. Method according to one claim 1, characterized in that a placing step a1), in which the flat stamped part (1) is placed on one of the punch surfaces (4, 5), in particular the lower punch surface (5), is carried out before, after, or during the positioning step a).

6. Method according to claim 1, characterized in that an upper punch surface (4) and a lower punch surface (5) with a smooth surface are used, and/or in that an upper punch surface (4) and a lower punch surface (5) with a shape similar to the shape of a top (6) and a bottom (7) of the flat stamped part (1) essentially of the same size are used.

7. Method according to claim 1, characterized in that before the positioning step a), a classifying step a0) is carried out, in which classifying step flat stamped parts (1) are divided into at least two groups, wherein a first group contains any flat stamped parts (1) whose thickness is at least as large as a predefined thickness, and another group contains any flat stamped parts (1) whose thickness is smaller than a predefined thickness, and in that the flat stamped part (1) used for the other method steps is removed from the first group.

8. Method according to claim 1, characterized in that a flat stamped part (1) is used, which flat stamped part (1) has a top (6) and a bottom (7) that are essentially of the same size, which are larger than the punch surfaces (4, 5), so that after the contact step b), the stamped part (1) protrudes over the punch surfaces (4, 5) at least in places.

9. Method according to claim 1, characterized in that punch surfaces (4, 5) with an outside edge (11) are used, and in the severing step e) or optionally in one of the severing steps e), the material (10) that protrudes outwardly over the outside edge (11) and transverse to the punch surface (S) is severed.

10. Method according to claim 9, characterized in that for severing the material (10) that protrudes outwardly over the outside edge (11) and transverse to the punch surface (S), a cutting-edge geometry (13) that runs with a cutting edge (14) around the upper punch (2) or around the lower punch (3), and that is arranged at some distance from the stamped part

(1) before the severing step e) or optionally in one of the severing steps e), is moved in the direction of the punch axis (S) to the other punch (2, 3) at least to the extent that the material (10) that protrudes outwardly is severed or sheared off by the cutting edge (14).

11. Method according to one claim 1, characterized in that punch surfaces (4, 5) with a recess (15) that in each case are of the same size and are centered relative to one another, which recess is bounded by an inside edge (16) of the punch surface (4, 5), are used, and in the severing step e) or optionally in one of the severing steps e), the material (10) that protrudes inwardly over the inside edge (16), transverse to the punch axis (S), is severed.

12. Method according to claim 11, characterized in that for severing the material (10) that protrudes inwardly over the inside edge (16) and transverse to the punch axis (S) in the severing step e) or optionally in one of the severing steps e), an inside punch (17) guided in the upper punch (2) or in the lower punch (3), which inside punch (17) has a cutting edge (14) running inside the recess (15) and which is arranged at some distance from the stamped part (1) before the severing step d), is moved along the punch axis (S) to the other punch (2, 3) at least to the extent that the material (10) that protrudes inwardly is severed or sheared off by the cutting edge (14).

13. Apparatus for producing a calibrated stamped part for use in the production of embossed products, in particular coins, from a flat stamped part (1), wherein the apparatus has an upper punch (2) and a lower punch (3) with a common punch axis (S), wherein an upper punch surface (4) of the upper punch (2) is oriented parallel to a lower punch surface (5) of the lower punch (3) that is preferably of the same size as well as centered thereto and to the punch axis (S), wherein the apparatus has at least one drive unit, with which one of the punches (2, 3) can move toward the other punch (3, 2) or the two punches (2, 3) can move toward one another along the punch axis (S), the punches (2, 3) are brought closer to one another along the punch axis (S), and wherein the apparatus has at least one severing means (12), with which material (10) that protrudes laterally over the punch surfaces (4, 5), transverse to the punch axis (S), can be severed.

14. Apparatus according to claim 13, characterized in that the apparatus has a positioning unit, with which the flat stamped part (1) can be positioned centered between the punch surfaces (4, 5) and preferably placed on one of the punch surfaces (4, 5).

15. Apparatus according to claim 13, characterized in that the drive unit or optionally at least one of the drive units can be operated in at least two drive modes, wherein in a feed mode, the punch(es) (2, 3) can be moved with a feed stroke (8), and in an operating mode, the punches (2, 3) can be brought closer to one another with a working stroke (9), and in that with the drive unit in the working mode, greater force can be exerted on the punch(es) (2, 3) than in the feed mode.

16. Apparatus according to claim 13, characterized in that the apparatus has at least two drive units, namely a feeding drive unit, with which punches (2, 3) can be moved with a feed stroke (8), and a working drive unit, with which the punches (2, 3) can be brought closer to one another with a working stroke (9), and in that with the working drive unit, greater force can be exerted on the punch(es) (2, 3) than with the feeding drive unit.

17. Apparatus according to claim 13, characterized in that the severing means (12) or optionally one of the severing means (12) is a cutting-edge geometry (13) running with a cutting edge (14) around the upper punch (2) or around the lower punch (3), which cutting-edge geometry (13) can move along the punch axis (S) to the other punch (2, 3).

18. Apparatus according to claim 13, characterized in that the severing means (12) or optionally one of the severing means (12) is an inside punch (17), which is guided in a recess (15) of the upper punch (2) or the lower punch (3) running in the direction of the punch axis (S), oriented central to the punch surfaces (4, 5), which has a cutting edge (14) running inside the recess (15), and which can move along the punch axis (S) to the other punch (2, 3).

19. Apparatus according to 18, claim 13, characterized in that one or optionally more of the severing means (12) or any of the severing means (12) can move with the drive unit or optionally one of the drive units, or in that one or optionally more of the severing means (12) or any of the severing means (12) has/have a separate cutting drive unit.

20. Apparatus according to claim 13, characterized in that the drive unit has a pneumatic drive or a hydraulic drive or optionally in that at least one of the drive units, in particular the feeding drive unit, has a pneumatic drive, and/or at least one of the drive units, in particular the working drive unit, has a hydraulic drive.
